(19) United States
(12) Patent Application Publication
(10) Pub. No.: US 2020/0004247 A1
(43) Pub. Date: Jan. 2, 2020

(54) CONTROLLING MOVEMENT OF AUTONOMOUS DEVICE

(71) Applicant: Mobile Industrial Robots A/S, Odense SØ (DK)

(72) Inventors: Niels Jul Jacobsen, Odense M (DK); Lourenço Barbosa De Castro, Odense (DK); Søren Eriksen Nielsen, Sonderborg (DK)

(21) Appl. No.: 16/025,483

(22) Filed: Jul. 2, 2018

(51) Int. Cl. G05D 1/00; G05D 1/02; B60Q 9/00

(52) U.S. Cl. CPC G05D 1/0088; G05D 1/0221; G05D 2201/02; G05D 1/0289; B60Q 9/008

(57) ABSTRACT

An example system includes an autonomous device. The system includes a movement assembly to move the autonomous device, memory storing information about classes of objects and storing rules governing operation of the autonomous device based on a class of an object in a path of the autonomous device, one or more sensors to detect at least one attribute of the object, and one or more processing devices. The one or more processing devices determine the class of the object based on the at least one attribute, execute a rule to control the autonomous device based on the class, and control the movement assembly based on the rule.

### TECHNICAL FIELD

This specification relates generally to controlling movement of an autonomous device based on a class of object encountered by the autonomous device.

### BACKGROUND

An autonomous device, such as a mobile robot, include sensors, such as scanners or three-dimensional (3D) cameras, to detect an object in its vicinity. The autonomous device may take action in response to detecting the object. For example, action may be taken to avoid collision with the object.

### SUMMARY

An example system comprises an autonomous device. The system comprises a movement assembly to move the autonomous device, memory storing information about classes of objects and storing rules governing operation of the autonomous device based on a class of an object in a path of the autonomous device, and one or more sensors configured to detect at least one attribute of the object. The one or more processing devices are configured—for example, programmed—to perform operations comprising: determining the class of the object based on the at least one attribute, executing a rule to control the autonomous device based on the class, and controlling the movement assembly based on the rule. In a case that the object is classified as an animate object, the rule to control the autonomous device comprises instructions for determining a likelihood of a collision with the object and for outputting an alert based on the likelihood of the collision. The example system may include one or more of the following features, either alone or in combination.

In a case that the object is classified as an animate object, the rule to control the autonomous device may comprise instructions for: controlling the movement assembly to change a speed of the autonomous device, detecting attributes of the object using the one or more sensors, and to reacting the object based on the attributes.

In a case that the object is classified as an animate object, the rule to control the autonomous device may comprise instructions for stopping movement of the autonomous device. In a case that the object is classified as an animate object, the rule to control the autonomous device may comprise instructions for altering a course of the autonomous device. The instructions for altering the course of the autonomous device may comprise instructions for estimating a direction of motion of the animate object and for altering the course based on the direction of motion.

In a case that the object is classified as an animate object, the rule to control the autonomous device may comprise instructions for reacting to the object based on a parameter indicative of a level of aggressiveness of the autonomous device.

The animate object may be a human. The alert may comprise an audible or visual warning to move out of the way of the autonomous device. The autonomous device may be a mobile robot. The classes of objects and the rules may be stored in the form of a machine learning model.

An example system comprises an autonomous device. The system comprises a movement assembly to move the autonomous device, memory storing information about classes of objects and storing rules governing operation of the autonomous device based on a class of an object in a path of the autonomous device, one or more sensors configured to detect at least one attribute of the object, and one or more processing devices. The one or more processing devices are configured—for example, programmed—to perform operations comprising: determining the class of the object based on the at least one attribute, executing a rule to control the autonomous device based on the class, and controlling the movement assembly based on the rule. In a case that the object is classified as a known robot, the rule to control the autonomous device comprises instructions for implementing communication to resolve a potential collision with the known robot. The example system may include one or more of the following features, either alone or in combination.

The classes of objects and rules may be stored in the form of a machine learning model. The instructions for implementing communication to resolve the potential collision may comprise instructions for communicating with the known robot to negotiate the course. The instructions for implementing communication to resolve the potential collision may comprise instructions for communicating with a control system to negotiate the course. The control system may be configured to control operation of both the autonomous device and the known robot. The control systems may comprise a computing system that is remote to both the autonomous device and the known robot. The at least one attribute may comprise information obtained from the known robot that the known robot is capable of communicating with the autonomous device. The autonomous device may be a mobile robot.

An example system comprises an autonomous device. The system comprises a movement assembly to move the autonomous device, memory storing information about classes of objects and storing rules governing operation of the autonomous device based on a class of an object in a path of the autonomous device, one or more sensors configured to detect at least one attribute of the object, and one or more processing devices. The one or more processing devices may be configured—for example, programmed—to perform operations comprising: determining the class of the object based on the at least one attribute, executing a rule to control the autonomous device based on the class, and controlling the movement assembly based on the rule. In a case that the object is classified as a static object, the rule to control the autonomous device comprises instructions for avoiding collision with the object and for cataloging the object if the object is unknown. The example system may include one or more of the following features, either alone or in combination.

The classes of objects and rules may be stored in the form of a machine learning model. The rule to control the autonomous device may comprise instructions for: comparing information about the object obtained through the one or more sensors to information in a database, and determining whether the object is an unknown object based on the comparing. The rule to control the autonomous device may comprise instructions for storing information in the database about the object if the object is determined to be an unknown object. The information may comprise a location of the object. The information may comprise one or more features of the object. The autonomous device may be a mobile robot.

An example system comprises an autonomous device. The system comprises a movement assembly to move the autonomous device, memory storing information about classes of objects and storing rules governing operation of the autonomous device based on a class of an object in a path of the autonomous device, one or more sensors configured to detect at least one attribute of the object, and one or more processing devices. The one or more processing devices are configured—for example, programmed—to perform operations comprising: determining the class of the object based on the at least one attribute, executing a rule to control the autonomous device based on the class, and controlling the movement assembly based on the rule. In a case that the object is classified as an unknown dynamic object, the rule to control the autonomous device comprises instructions for determining a likely direction of motion of the unknown dynamic object and for controlling the movement assembly to avoid the unknown dynamic object. The example system may include one or more of the following features, either alone or in combination.

The classes of objects and rules may be stored in the form of a machine learning model. The rule to control the autonomous device may comprise instructions for determining a speed of the unknown dynamic object and for controlling the movement assembly based, at least in part, on the speed. Controlling the movement assembly to avoid the unknown dynamic object may comprise altering a course of the autonomous device. The course of the autonomous device may be altered based on the likely direction of motion of the unknown dynamic object. The rule to control the autonomous device may comprise instructions for: controlling the movement assembly to change a speed of the autonomous device, detecting attributes of the object using the one or more sensors, and reacting to the object based on the attributes. The autonomous device may be a mobile robot.

Any two or more of the features described in this specification, including in this summary section, can be combined to form implementations not specifically described herein.

The systems and processes described herein, or portions thereof, can be controlled by a computer program product that includes instructions that are stored on one or more non-transitory machine-readable storage media, and that are executable on one or more processing devices to control (e.g., coordinate) the operations described herein. The systems and processes described herein, or portions thereof, can be implemented as an apparatus or method. The systems and processes described herein can include one or more processing devices and memory to store executable instructions to implement various operations.

The details of one or more implementations are set forth in the accompanying drawings and the description below. Other features and advantages will be apparent from the description and drawings, and from the claims.

### DESCRIPTION OF THE DRAWINGS

FIG. 1 is a side view of an example autonomous robot.

FIG. 2 is a flowchart containing example operations that may executed by a control system to identify a class of an object.

FIG. 3 is a flowchart containing example operations that may executed by the control system in the event that the object is classified as static.

FIG. 4 is a flowchart containing example operations that may executed by the control system in the event that the object is classified as an animate object.

FIG. 5 is a flowchart containing example operations that may executed by the control system in the event that the object is classified as a known object.

FIG. 6 is a flowchart containing example operations that may executed by the control system in the event that the object is classified as an unknown dynamic (e.g., mobile) object.

FIG. 7 is a side view of the example autonomous robot, which shows ranges of long-range sensors included on the robot.

FIG. 8 is a top view of the example autonomous robot, which shows ranges of the long-range sensors included on the robot.

FIG. 9 is a top view of the example autonomous robot, which shows short-range sensors arranged around parts of the robot.

FIG. 10 is a side view of the example autonomous robot, which shows the short-range sensors arranged around parts of the robot and their fields of view.

FIG. 11 is a top view of the example autonomous robot, which shows the short-range sensors arranged around parts of the robot and their fields of view.

FIG. 12 is a side view of the example autonomous robot, which shows a bumper and the short-range sensors underneath or behind the bumper.

Like reference numerals in different figures indicate like elements.

### DETAILED DESCRIPTION

Described herein are examples of autonomous devices or vehicles, such as a mobile robot. An example autonomous device (or simply “device”) is configured to move along a surface, such as the floor of factory. The device includes a body for supporting the weight of an object and a movement assembly. The movement assembly may include wheels and a motor that is controllable to drive the wheels to enable the body to travel across the surface. The device also includes one or more sensors on the body. The sensors are configured for detection in a field of view (FOV) or simply “field”. For example, the device may include a three-dimensional (3D) camera that is capable of detecting an object in its path of motion.

The sensors are also configured to detect one or more attributes of the object. The attributes include features that are attributable to a particular type, or class, of object. For example, the sensors may be configured to detect one or more attributes indicating that the object is an animate object, such as a human or an animal. For example, the sensors may be configured to detect one or more attributes indicating that the object is a known object, such as a robot that is capable of communicating with the autonomous device. For example, the sensors may be configured to detect one or more attributes indicating that the object is an unknown dynamic object, such as a robot that is not capable of communicating with the autonomous device. For example, the sensors may be configured to detect one or more attributes indicating that the object is a static object, such as a structure that is immobile. The operation of the autonomous device may be controlled by a control system based on the class of the object.

In some implementations, the autonomous device may include an on-board control system comprised of memory and one or more processing devices. In some implementations, the autonomous device may be configured to communicate with a remote control system comprised of memory and one or more processing devices. The remote control system is not on-board the autonomous device. In either case, the control system is configured to process data based on signals received from on-board sensors or other remote sensors. The data may represent attributes of the object detected by the sensors. Computer memory may store information about classes of objects and rules governing operation, such as motion, of the autonomous device based on a class of an object in a path of, or the general vicinity of, the autonomous device and/or attributes of the object. The rules can be obtained or learned by applying artificial intelligence, such as machine learning-based techniques.

The attributes represented by the data may be compared against information—which may include a library of attributes for different classes—stored in computer memory in order to identify a class of the object in the path of the device. The control system may execute one or more rules stored in computer memory based on the determined class, and control the movement of device through execution of the rules. For example, if the object is determined to be an animate object, such as a human, the device may be controlled to emit a verbal or visible warning. For example, if the object is determined to be an animate object, such as an animal, the device may be controlled to emit a loud noise or a bright light. For example, if the object is determined to be an animate object, such as a human or animal, the device may be controlled to anticipate future movement of the animate object based on the animate object's current attributes such as, but not limited to, moving direction, speed, and facial expression. The device may then be controlled to navigate around the animate object based on its anticipated future movement. For example, if the object is determined to be a static object, the device may be controlled to navigate around the static object. For example, if the object is determined to be a known object, such as a known robot, the device may be controlled to communicate with a control system to negotiate a navigational path of the device, the known object, or both. For example, if the object is determined to be an unknown dynamic object, the device may be controlled to anticipate future movement of the unknown dynamic object, and to navigate around the unknown dynamic object based on its anticipated future movement.

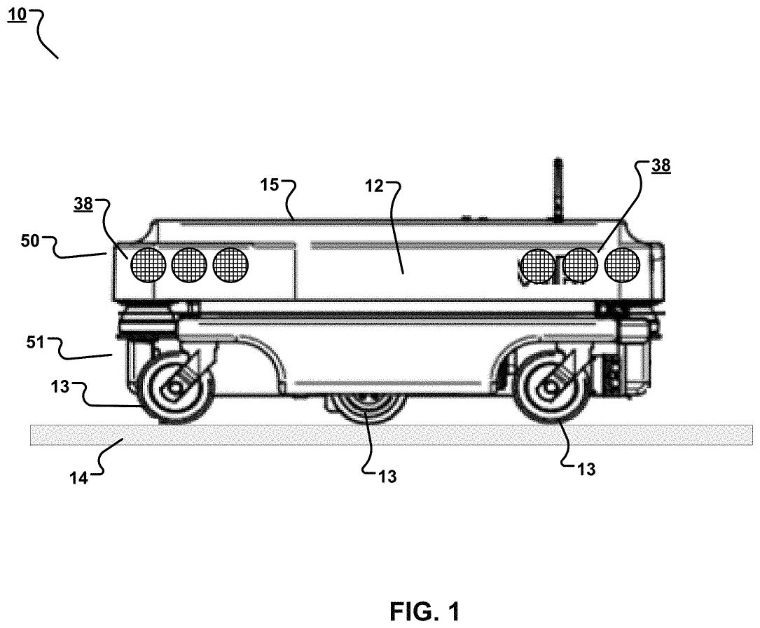

An example of an autonomous device is autonomous robot 10 of FIG. 1. In this example, autonomous robot 10 is a mobile robot, and is referred to simply as “robot”. Robot 10 includes a body 12 having wheels 13 to enable robot 10 to travel across a surface 14, such as the floor of a factory or other terrain. Robot 10 also includes a support area 15 configured to support the weight of an object. In this example, robot 10 may be controlled to transport the object from one location to another location. Robot 10 includes long-range sensors and short-range sensors to detect objects in its vicinity. The long-range sensors and the short-range sensors are described below. The long-range sensors, the short-range sensors, or a combination of the long-range sensors and the short-range sensors may be used to detect objects in the vicinity of—for example, in the path of—the robot and to detect one or more attributes of each such object.

Signals from the long-range sensors and from the short-range sensors may be processed by a control system, such as a computing system, to identify an object near to, or in the path of, the robot. If necessary, navigational corrections to the path of the robot may be made, and the robot's movement system may be controlled based on those corrections. As noted, the control system may be local. For example, the control system may include an on-board computing system located on the robot itself. As noted, the control system may be remote. For example, the control system may be a computing system external to the robot. In this example, signals and commands may be exchanged wirelessly to control operation of the robot. Controlling operation of the robot may include, but is not limited to, controlling the direction and speed of the robot, controlling the robot to emit sounds, light, or other warnings, or controlling the robot to stop motion of the robot.

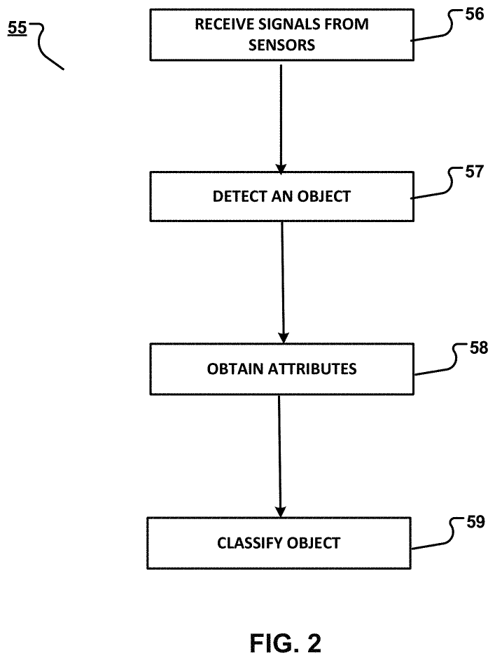

FIGS. 2, 3, 4, 5, and 6 show example operations that may executed by the control system to identify the class of an object in the vicinity of a robot, and to control operation of the robot based on a rule for objects in that class. The operations may be coded as instructions stored on one or more non-transitory machine-readable media, and executed by one or more processing devices in the control system.

Referring to FIG. 2, operations 55 include receiving (56) signals from sensors on the robot. As described herein, the signals may be received from different types of sensors and from sensors having different ranges. The signals are used to detect (57) an object in the vicinity of the robot. For example, signals emitted from, or reflected from, the object may be received by a sensor. The sensor may output these signals, or other signals derived therefrom, to the control system. Depending upon whether the control system is on-board or remote, the signals may be output via wired or wireless transmission media. The signals may be converted to data to be processed using a microprocessor or may be processed using a digital signal processor (DSP).

The control system analyzes the data or the signals themselves to detect (57) an object. In some implementations, the system may require signals from multiple sensors, signals having minimum magnitudes, or some combination thereof in order to identify an object positively. For example, signals that are considered weak, may be stray signals within the environment that do not indicate the presence of an object. The control system may filter-out or ignore such signals when detecting an object. In some implementations, signals from different sensors on the same robot may be correlated to confirm that those different sensors are sensing an object in the same location having consistent attributes, such as size. Different robots may have different criteria for detecting an object, including those described herein and those not described.

After an object has been detected (57), attributes are obtained (58) and the object is classified (59). To classify the object, the control system analyzes attributes of the object. In this regard, the signals or data based on those signals also include attributes of the object. Attributes of the object include, but are not limited to, features or characteristics of the object or its surroundings. For example, attributes of an object may include, but are not limited to, its size, color, structure, shape, weight, mass, density, location, environment, chemical composition, temperature, scent, gaseous emissions, opacity, reflectivity, radioactivity, manufacturer, distributor, place of origin, functionality, communication protocol(s) supported, electronic signature, radio frequency identifier (RFID), compatibility with other devices, ability to exchange communications with other devices, mobility, and markings such as bar codes, quick response (QR) codes, and instance-specific markings such as scratches or other damage. Appropriate sensors may be incorporated into the robot to detect any one or more of the foregoing attributes, and to output signals representing one or more attributes detected.

In some implementations, the attributes may be provided from other sources, which may be on-board the robot or external to the robot. For example, external environmental motion sensors, temperature sensors, gas sensors, or the like may provide attributes of the object. These sensors may communicate with the robot or the control system. For example, upon encountering an object, the robot may communicate with one or more environmental sensors to obtain attributes corresponding to the geographic coordinates of the object. For example, upon the robot encountering an object, the control system may communicate with one or more environmental sensors to obtain attributes corresponding to the geographic coordinates of the object.

Analyzing attributes of the object (“the object attributes”) may include comparing the object attributes to a library of stored attributes (“the stored attributes”). The library may be stored in computer memory. For example, the library may include one or more look-up tables (LUTs) or other appropriate data structures that are used to implement the comparison. For example, the library and rules may be stored in the form of a machine leaning model such as, but not limited to, fuzzy logic, a neural network, or deep learning. The stored attributes may include attributes for different classes of objects, such as animate objects, static objects, known objects, or unknown dynamic objects. The object attributes are compared to the stored attributes for different classes of objects. The stored attributes that most closely match the object attributes indicate the class of the object. In some implementations, a match may require an exact match between some set of stored attributes and object attributes. In some implementations, a match may be sufficient if the object attributes are within a predefined range of the stored attributes. For example, object attributes and stored attributes may be assigned numerical values. A match may be declared between the object attributes and the stored attributes if the numerical values match identically or if the numerical values are within a certain percentage of each other. For example, a match may be declared if the numerical values for the objects attributes deviate from the stored attributes by no more than 1%, 2%, 3%, 4%, 5%, or 10%, for example. In some implementations, a match may be declared if a number or recognized features are present. For example, there may be a match if three or four out of five recognizable features are present.

In some implementations, the attributes may be weighted based on factors such as importance. For example, shape may be weighted more than other attributes, such as color. So, when comparing the object attributes to the stored attributes, shape may have a greater impact on the outcome of the comparison than color.

The control system thus classifies (59) the object based on one or more of the object attributes. In some implementations, there are four classes of objects; however, different systems may produce different numbers and types of classes of objects. In this example as previously noted, the classes include animate object, static object, known object, and unknown dynamic object. An animate object may be is classified based, for example, on attributes such as size, shape, mobility, or temperature. A static object may be classified based, for example, on attributes such as mobility, location, features, structure, opacity, or reflectively. A known object may be classified based, for example, on manufacturer, place of origin, functionality, communication protocol(s) supported, electronic signature, radio frequency identifier (RFID), compatibility with other devices, ability to exchange communications with other devices, mobility, or markings such as bar codes, quick response (QR) codes, and instance-specific markings such as scratches or other damage. An unknown dynamic object may be classified based, for example, on mobility, structure, size, shape, and a lack of one or more other known attributes, such as manufacturer, place of origin, functionality, communication protocol(s) supported, electronic signature, radio frequency identifier (RFID), compatibility with other devices, ability to exchange communications with other devices, or markings such as bar codes, quick response (QR) codes, and instance-specific markings such as scratches or other damage.

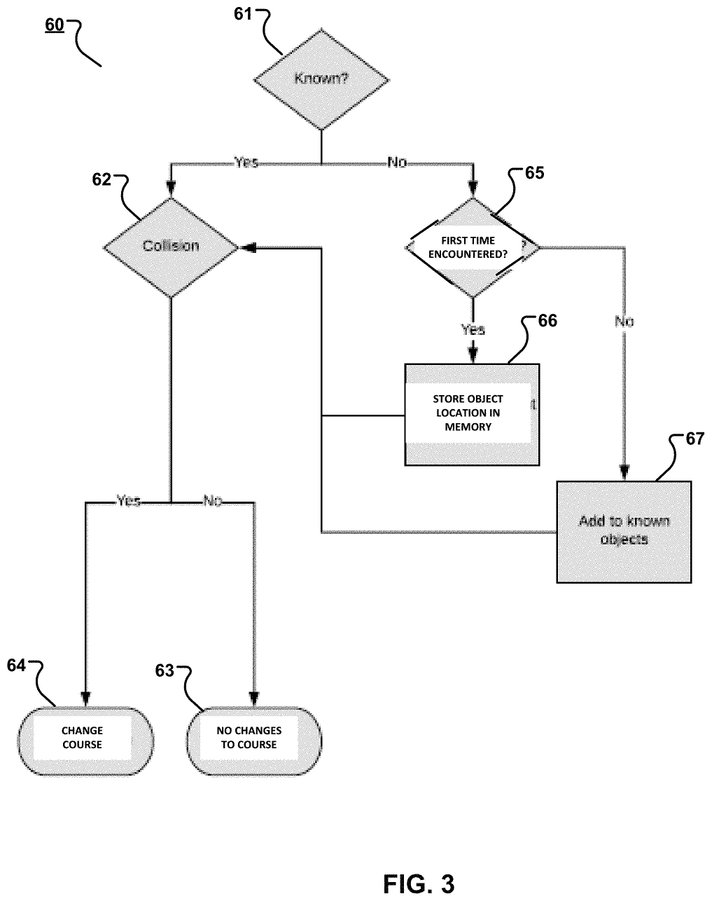

FIG. 3 shows example operations 60 that may executed by the control system in the event that the object is classified as static. The operations define a rule to control the robot based on the object's “static” class. In this case where the object is classified as static, the rule to control the robot includes instructions for avoiding collision with the object and for cataloging the object if the object has not been encountered previously.

Operations 60 include determining (61) whether the object is known. An object may be determined to be a known object if it has previously been encountered by the robot or if it is within set of known objects programmed into the robot or a database. In this regard, known objects may have unique sets of attributes, which may be stored in the database. Accordingly, the control system may determine whether the object is known by comparing the object attributes to one or more sets of attributes for known objects stored in the database. Examples of known static objects may include, but are not limited to, walls, tables, benches, and factory machinery.

If the object is determined to be known (61), the control system determines (62) whether the current and projected course (e.g., the navigational route) and speed of the robot will result in a collision with the object. To do this, geographic coordinates of the current and projected course are compared with geographic coordinates of the object, taking into account the sizes and shapes of the robot and the object. If a collision will not result, no changes (63) to the robot's current and projected course are made. If a collision will result, changes (64) to the robot's current and projected course are made. For example, the control system may determine a new course that avoids the object, and control the robot—in particular, its movement assembly—based on the new course. The new course may be programmed into the robot either locally or from a remote control system and the robot may be controlled to follow the new course.

If the object is determined not to be known (61), the control system determines (65) if this is the first time the object has been encountered. In an example, attributes of the object may be compared to stored library attributes to make this determination. In an example, attributes of the object may be used as input to a machine learning model to make this determination. If this is the first time that the object has been encountered, the current location of the object is stored (66) in computer memory. The location may be defined in terms of geographic coordinates: local or global, for example. If this is not the first time that the object has been encountered by any robot, the object is added (67) to a set of known objects in stored in computer memory. After operations 66 or 67, processing proceeds to operation 62 to determine whether there will be a collision with the object, as shown.

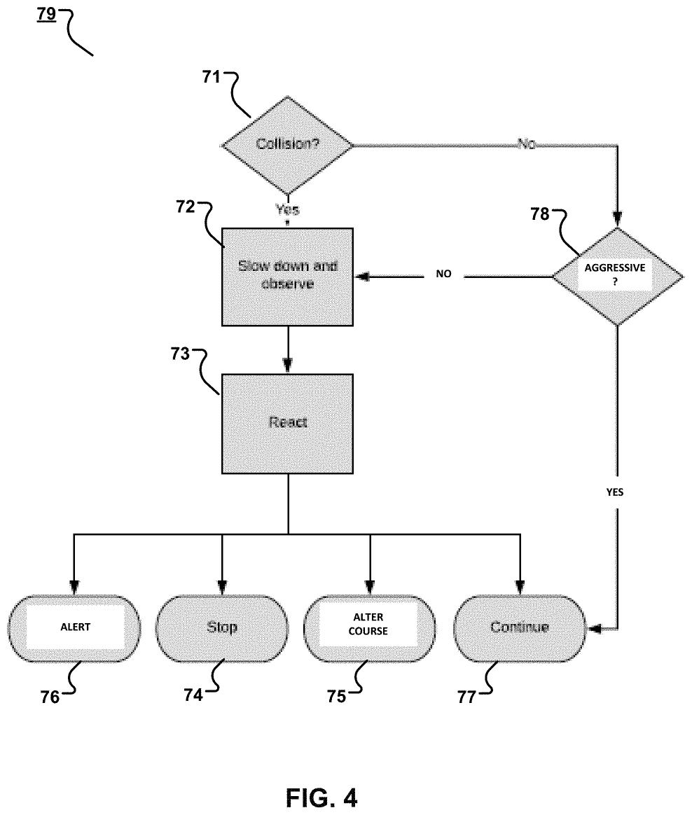

FIG. 4 shows show example operations 70 that may executed by the control system in the event that the object is classified as an animate object—in this example, a human. The operations define a rule to control the robot based on the object's “animate” class. In this case where the object is classified as human, the rule to control the robot includes instructions for determining a likelihood of a collision with the object and for outputting an alert based on the likelihood of the collision.

Operations 70 include determining (71) whether the current and projected course of the robot will result in a collision with the object. To do this, geographic coordinates of the current and projected course are compared with geographic coordinates of the object, taking into account the sizes and shapes of the robot and the object. In addition, estimated immediate future motion of the object is taken into account. For example, if the object is moving in a certain direction, continued motion in that direction may be assumed, and the likelihood of collision is based on this motion, at least in part. For example, if the object is static, continued stasis may be assumed, and the likelihood of collision is based on this lack of motion, at least in part. In some scenarios, if a collision will not result, no changes to the robot's current and projected course are made. The robot's movement continues unabated, as described below.

If it is determined (71) that a collision will result, the robot may be controlled to slow its speed or to stop and to observe (72) the object—for example, to sense the object continually over a period of time and in real-time. To implement operation 72, the robot's movement assembly is controlled to change a speed of the robot, and the robot's sensors are controlled to continue detection of attributes, such as mobility, of the object. The robot is controlled to react (73) based on any newly-detected attributes. For example, the sensors may indicate that the object has continued movement in its prior direction, has stopped, or has changed its direction of position. This information may be used to dictate the robot's future reaction to the object.

In some implementations, the rule may include instructions for stopping (74) movement of the robot. For example, the robot may stop motion and wait for the object to pass or to move out of its way. In some implementations, the rule may include instructions for altering (75) a course of the robot. For example, the control system may generate an altered navigational route for the robot based on the estimated direction of motion of the object, and control the robot based on altered navigational route. In other words, the control system may determine a new course that avoids the object, and control the robot—in particular, its movement assembly—based on the new course. The new course may be programmed into the robot either locally or from a remote control system. In some implementations, the rule may include instructions for outputting an alert (76) based on the likelihood of the collision. For example, the robot, the control system, or both may output an audible warning, a visual warning, or both an audible warning and a visual warning instructing the object to move out of the way of the robot. The warning may increase in volume, frequency, and/or intensity as the robot moves closer to the object. If the robot comes to within a predefined distance of the object, and the object has still not moved out of its way as determined by the sensors, the robot may stop motion and wait for the object to pass or alter its navigational route to avoid the object. In some implementations, for example, if the object moves out of the way in time, the robot will continue (77) on its current and present course.

In some implementations, the robot may be programmed to include a parameter indicative of a level of aggressiveness. For example, if the robot is programmed to be more aggressive (78), if it is determined (71) that a collision will not result, the robot will continue (77) on its current and projected course without reaction. For example, if the robot is programmed to be less aggressive (78), even if it is determined (71) that a collision will not result, the robot will still react. In this example, the robot may be controlled to slow its speed or to stop and to observe (72)—for example, to sense continually in real-time—the object. The robot may then react, if necessary, as set forth in operations 73 through 77 of FIG. 4. If no reaction is needed—for example, if there continues to be no threat of collision with the object—the robot will continue (77) on its current and projected course without further reaction.

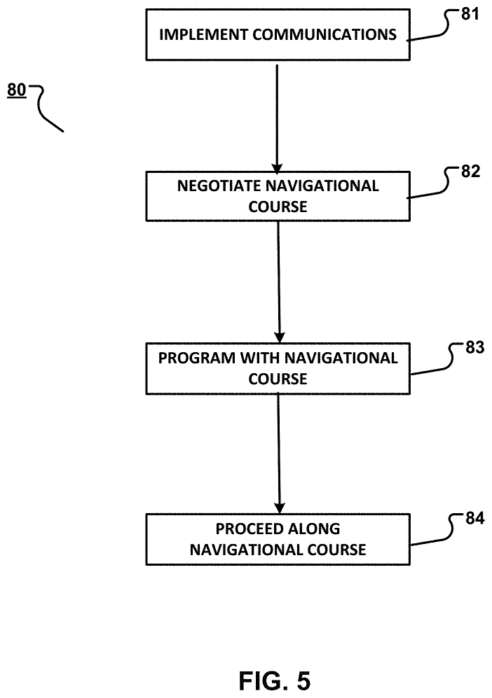

FIG. 5 shows show example operations 80 that may executed by the control system in the event that the object is classified as a known object—in this example, a known robot. An object may be classified as known if, for example, the object is capable of communicating with the robot, has the same manufacturer as the robot, or is controlled by the same control system as the robot.

The operations define a rule to control the robot based on the object's class. In a case that the object is classified as known, the rule to control the robot includes instructions for implementing communication (81) with the known robot or with a control system that controls both the robot and the known robot to resolve a potential collision with the known robot. The communications may include sending communications to, and receiving communications from, the known robot to negotiate (82) navigational courses of one or both of the robot and the known robot so as to avoid a collision between the two. The communications may include sending communications to, and receiving communications from, the control system to negotiate (82) navigational courses of one or both of the robot and the known robot so as to avoid a collision between the two. The robot, the known robot, or both the robot and the known robot may be programmed (83) with new, different, or unchanged navigational courses to avoid a collision. The robot then proceeds (84) along the programmed navigational course, as does the other, known robot, thereby avoiding, or at least reducing the possibility of, collision.

In some implementations, for known objects (e.g., robots), both robots may be pre-programmed to use identical sets of traffic rules. Traffic rules may include planned ways to navigate when meeting other known objects. For example, a traffic rule may require two robots always to pass each other on the left or the right, or always to give way in certain circumstances based, for example, on which robot enters an area first or which robot comes from an area that needs clearing before other areas. By using identical traffic rules, in some examples amounts of processing may be reduced and re-navigation may be faster, smoother, or both faster and smoother.

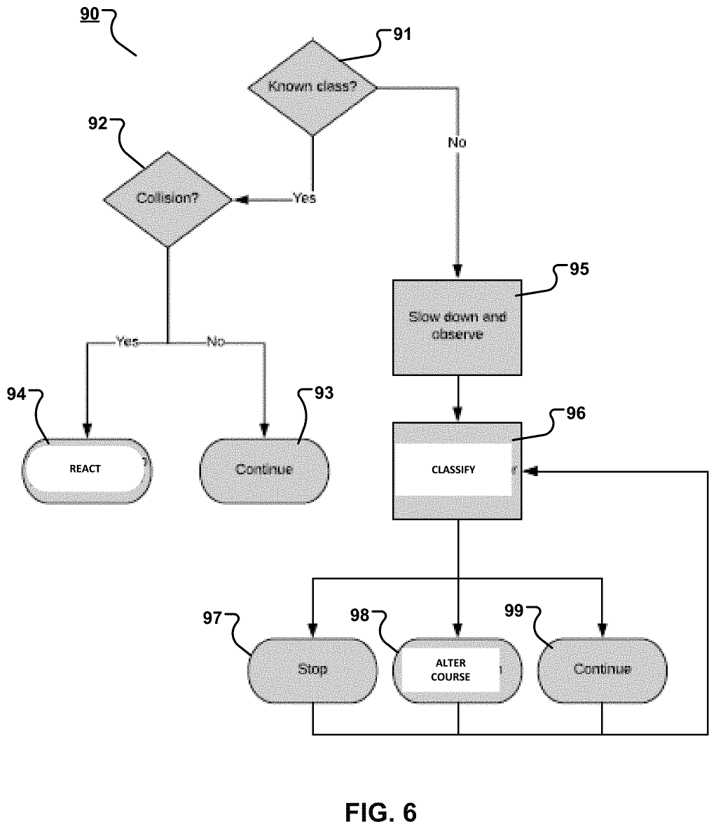

FIG. 6 shows show example operations 90 that may executed by the control system in the event that the object is classified as an unknown dynamic (e.g., mobile) object. The operations define a rule to control the robot based on the object's class. In this case where the object is classified as an unknown dynamic object, the rule includes instructions for determining a likely direction of motion of the unknown dynamic object and for controlling the movement assembly to avoid the unknown dynamic object.

The control system determines (91) if the object may be in a known class, such as a human or a known robot. For example, the object may have attributes that do not definitively place the object in a particular class, but that that make it more likely than not that the object is a human or a known robot. If that is the case (e.g., the robot is likely part of a known class that is not static), the control system determines (92) whether a collision is likely with the object if the robot remains on its current and projected course. If a collision is not likely, then the robot may continue (93) on its current and projected course. If a collision is likely, then the robot may react (94) according to the likely classification of the object—for example a human or a known robot. Example reactions are set forth in FIGS. 4 and 5, respectively.

If the control system is unable to determine (91) if the object is likely a human or a known robot, the robot may be controlled to slow its speed or to stop and to observe (95) the object—for example, to sense it continually in real-time. Generally, the robot's movement assembly is controlled to change a speed of the robot; the robot's sensors are controlled to continue detection of attributes, such as mobility, of the object; and the robot is controlled to react based on the newly-detected attributes. For example, the sensors may indicate that the object has continued movement in its prior direction, has stopped, or has changed its direction, its speed, or its position. This information may be used to dictate the robot's reaction to the object. In some implementations, this information may be used to classify (96) the robot as either a human or a known robot and to control the robot to react accordingly, as described herein.

In some implementations, the rule may include instructions for stopping (97) movement of the robot. For example, the robot may stop motion and wait for the object to pass or to move out of its way. In some implementations, the rule may include instructions for changing or altering (98) a course of the robot. For example, the control system may generate an altered navigational route for the robot based on the estimated direction of motion of the object, and control the robot based on altered navigational route. In some implementations, the rule may include instructions for outputting an alert based on the likelihood of the collision. For example, the robot, the control system, or both may output an audible warning, a visual warning, or both an audible warning and a visible warning instructing the object to move out of the way of the robot. The warning may increase in volume, frequency, and/or intensity as the robot moves closer to the object. If the robot comes to within a predefined distance of the object, and the object has still not moved out of its way, the robot may stop motion and wait for the object to pass or alter its navigational route to avoid the object. In some implementations, the robot may continue (99) along its current and projected course, for example, if the object moves.

Operations 96 to 99 may be repeated, as appropriate, if the robot remains on-course to collide with the object.

Referring back to FIG. 1, in an example, robot 10 that may be controlled based on the operations of FIGS. 2, 3, 4, 5, and 6 includes two types of long-range sensors: a three-dimensional (3D) camera and a light detection and ranging (LIDAR) scanner. However, the robot is not limited to this configuration. For example, the robot may include a single long-range sensor or a single type of long-range sensor. For example, the robot may include more than two types of long-range sensors.

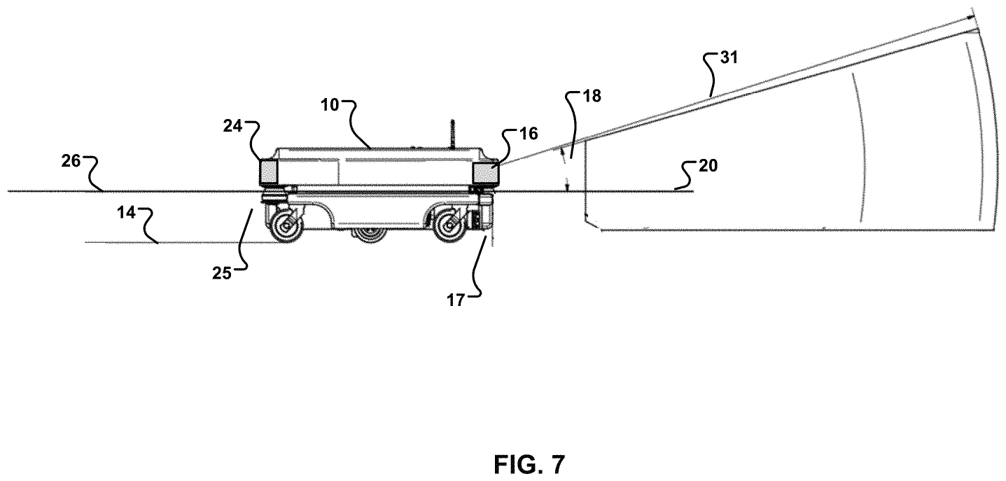

Referring to FIG. 7, robot 10 includes 3D camera 16 at a front 17 of the robot. In this example, the front of the robot faces the direction of travel of the robot. The back of the robot faces terrain that the robot has already traversed. In this example, 3D camera 16 has a FOV 18 off of horizontal plane 20. In this example, the 3D camera has a sensing range 31. One or more additional 3D cameras may also be included at appropriate locations (e.g., the sides or the back) of the robot. Robot 10 also includes a LIDAR scanner 24 at its back 25. In this example, the LIDAR scanner is positioned at a back corner of the robot. The LIDAR scanner is configured to detect objects within a sensing plane 26. A similar LIDAR scanner is included at the diagonally opposite front corner of the robot, which has the same scanning range and limitations. One or more additional LIDAR scanners may also be included at appropriate locations on the robot.

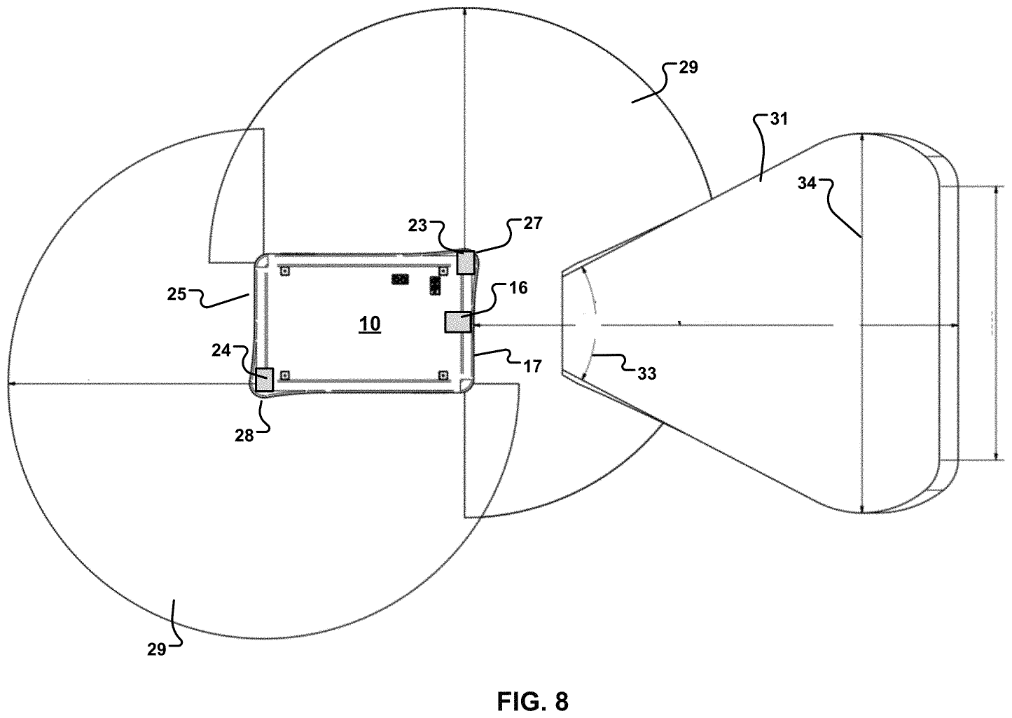

FIG. 8 is a top view of robot 10. LIDAR scanners 24 and 23 are located at back corner 28 and at front corner 27, respectively. In this example, each LIDAR scanner has a scanning range 29 over an arc of about 2700. As shown in FIG. 8, the range 31 of 3D camera 16 is over an arc 33. However, after a plane 34, the field of view of 3D camera 16 decreases, as shown.

Short-range sensors are incorporated into the robot to sense in the areas that cannot be sensed by the long-range sensors. In some implementations, each short-range sensor is a member of a group of short-range sensors that is arranged around, or adjacent to, each corner of the robot. The FOVs of at least some of the short-range sensors in each group overlap in whole or in part to provide substantially consistent sensor coverage in areas near the robot that are not visible by the long-range sensors. In some cases, complete overlap of the FOVs of some short range sensors may provide sensing redundancy.

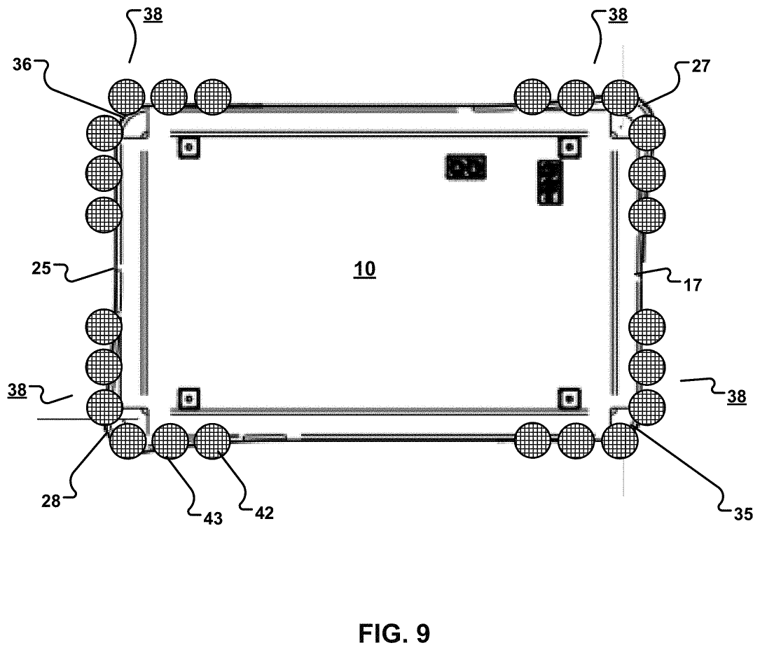

In the example of FIG. 9, robot 10 includes four corners 27, 28, 35, and 36. In some implementations, there are two or more short-range sensors arranged at each of the four corners so that FOVs of adjacent short-range sensors overlap in part. For example, there may be two short-range sensors arranged at each corner; there may be three short-range sensors arranged at each corner; there may be four short-range sensors arranged at each corner; there may be five short-range sensors arranged at each corner; there may be six short-range sensors arranged at each corner; there may be seven short-range sensors arranged at each corner; there may be eight short-range sensors arranged at each corner, and so forth. In the example of FIG. 9, there are six short-range sensors 38 arranged at each of the four corners so that FOVs of adjacent short-range sensors overlap in part. In this example, each corner comprises an intersection of two edges. Each edge of each corner includes three short-range sensors arranged in series. Adjacent short-range sensors have FOVs that overlap in part. At least some of the overlap may be at the corners so that there are no blind spots for the mobile device in a partial circumference of a circle centered at each corner.

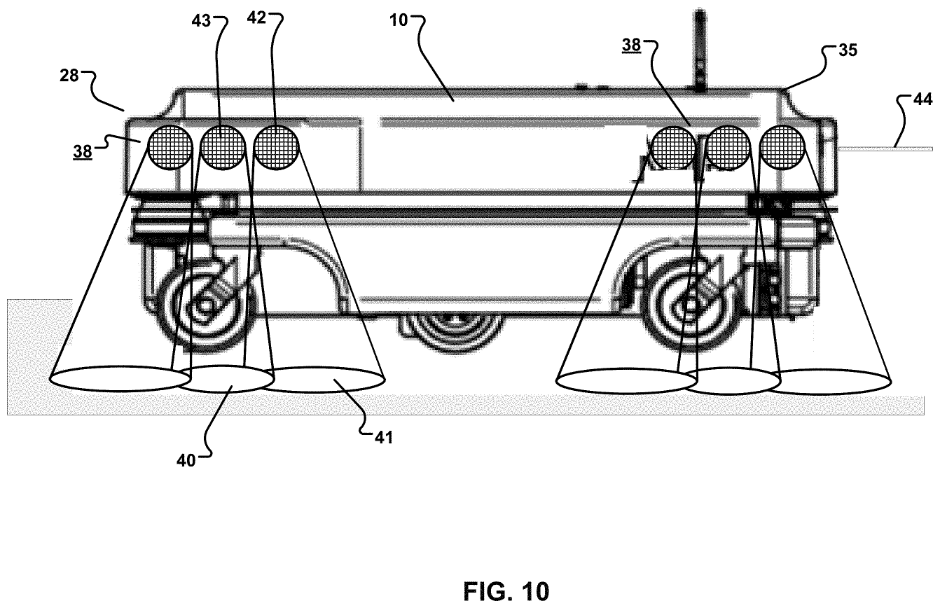

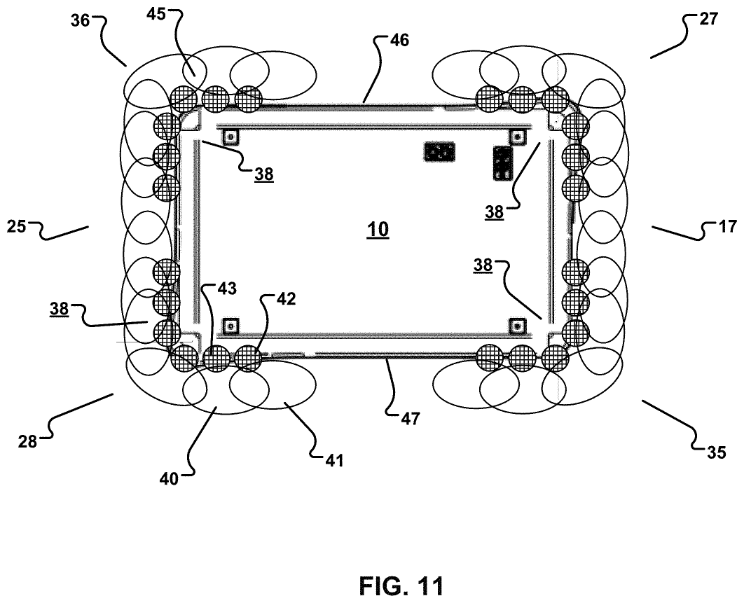

FIGS. 1, 9, 10, and 11 show different views of the example sensor configuration of robot 10. As explained above, in this example, there are six short-range sensors 38 arranged around each of the four corners 27, 28, 35, and 36 of robot 10. As shown in FIGS. 10 and 11, FOVs 40 and 41 of adjacent short-range sensors 42 and 43 overlap in part to cover all, some, or portions of blind spots on the robot that are outside—for example, below—the FOVs of the long-range sensors.

Referring to FIG. 10, the short-range sensors 38 are arranged so that their FOVs are directed at least partly towards surface 14 on which the robot travels. In an example, assume that horizontal plane 44 extending from body 12 is at 00 and that the direction towards surface 14 is at −90° relative to horizontal plane 44. The short-range sensors 38 may be directed (e.g., pointed) toward surface 14 such that the FOVs of all, or of at least some, of the short-range sensors are in a range between −1° and −90° relative to horizontal plane 44. For example, the short-range sensors may be angled downward between −1° and −90° relative to horizontal plane 44 so that their FOVs extend across the surface in areas near to the robot, as shown in FIGS. 10 and 11. The FOVs of the adjacent short-range sensors overlap partly. This is depicted in FIGS. 10 and 11, which show adjacent short-range sensor FOVs overlapping in areas, such as area 45 of FIG. 11, to create combined FOVs that cover the entirety of the front 17 of the robot, the entirety of the back 25 of the robot, and parts of sides 46 and 477 of the robot. In some implementations, the short-ranges sensors may be arranged to combine FOVs that cover the entirety of sides 46 and 47.

In some implementations, the FOVs of individual short-range sensors cover areas on surface 14 having, at most, a diameter of 10 centimeters (cm), a diameter of 20 cm, a diameter of 30 cm, a diameter of 40 cm, or a diameter of 50 cm, for example. In some examples, each short-range sensor may have a sensing range of at least 200 mm; however, other examples may have different sensing ranges.

In some implementations, the short-range sensors are, or include, time-of-flight (ToF) laser-ranging modules, an example of which is the VL53L0X manufactured by STMicroelectronics®. This particular sensor is based on a 940 nanometer (nm) “class 1” laser and receiver. However, other types of short-range sensors may be used in place of, or in addition to, this type of sensor. In some implementations, the short-range sensors may be of the same type or of different types. Likewise, each group of short-range sensors—for example, at each corner of the robot—may have the same composition of sensors or different compositions of sensors. One or more short-range sensors may be configured to use non-visible light, such as laser light, to detect an object. One or more short-range sensors may be configured to use infrared light to detect the object. One or more short-range sensors may be configured to use electromagnetic signals to detect the object. One or more short-range sensors may be, or include, photoelectric sensors to detect the object. One or more short-range sensors may be, or include, appropriately-configured 3D cameras to detect the object. In some implementations, combinations of two or more of the preceding types of sensors may be used on the same robot. The short-range sensors on the robot may be configured to output one or more signals in response to detecting an object.

The short-range sensors are not limited to placement at the corners of the robot. For example, the sensors may be distributed around the entire perimeter of the robot. For example, in example robots that have circular or other non-rectangular bodies, the short-range sensors may be distributed around the circular or non-rectangular perimeter and spaced at regular or irregular distances from each other in order to achieve overlapping FOV coverage of the type described herein. Likewise, the short-range sensors may be at any appropriate locations—for example, elevations—relative to the surface on which the robot travels.

Referring back to FIG. 1 for example, body 12 includes a top part 50 and a bottom part 51. The bottom part is closer to surface 14 during movement of the robot than is the top part. The short-range sensors may be located on the body closer to the top part than to the bottom part. The short-range sensors may be located on the body closer to the bottom part than to the top part. The short-range sensors may be located on the body such that a second field of each short-range sensor extends at least from 15 centimeters (cm) above the surface down to the surface. The location of the short-range sensors may be based, at least in part, on the FOVs of the sensors. In some implementations, all of the sensors may be located at the same elevation relative to the surface on which the robot travels. In some implementations, some of the sensors may be located at different elevations relative to the surface on which the robot travels. For example, sensors having different FOVs may be appropriately located relative to the surface to enable coverage of blinds spots near to the surface.

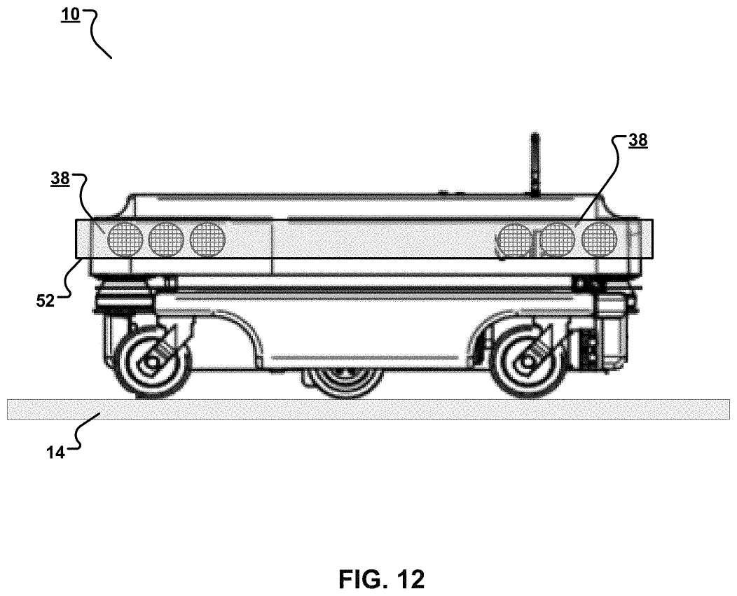

In some implementations, such as that shown in FIG. 12, robot 10 may include a bumper 52. The bumper may be a shock absorber and may be elastic, at least partially. The short-range sensors 38 may be located behind or underneath the bumper. In some implementations, the short-range sensors may be located underneath structures on the robot that are hard and, therefore, protective.

In some implementations, the direction that the short-range sensors point may be changed via the control system. For example, in some implementations, the short-range sensors may be mounted on body 12 for pivotal motion, translational motion, rotational motion, or a combination thereof. The control system may output signals to the robot to position or to reposition the short-range sensors, as desired. For example if one short-range sensor fails, the other short-range sensors may be reconfigured to cover the FOV previously covered by the failed short-range sensor. In some implementations, the FOVs of the short-range sensors and of the long-range sensors may intersect in part to provide thorough coverage in the vicinity of the robot.

The dimensions and sensor ranges presented herein are for illustration only. Other types of autonomous devices may have different numbers, types, or both numbers and types of sensors than those presented herein. Other types of autonomous devices may have different sensor ranges that cause blind spots that are located at different positions relative to the robot or that have different dimension than those presented. The short-range sensors described herein may be arranged to accommodate these blind spots.

The example robot described herein may include, and/or be controlled using, a control system comprised of one or more computer systems comprising hardware or a combination of hardware and software. For example, a robot may include various controllers and/or processing devices located at various points in the system to control operation of its elements. A central computer may coordinate operation among the various controllers or processing devices. The central computer, controllers, and processing devices may execute various software routines to effect control and coordination of the various automated elements.

The example robot described herein can be controlled, at least in part, using one or more computer program products, e.g., one or more computer program tangibly embodied in one or more information carriers, such as one or more non-transitory machine-readable media, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing at least part of the robot can be performed by one or more programmable processors executing one or more computer programs to perform the functions described herein. At least part of the robot can be implemented using special purpose logic circuitry, e.g., an FPGA (field programmable gate array) and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only storage area or a random access storage area or both. Elements of a computer (including a server) include one or more processors for executing instructions and one or more storage area devices for storing instructions and data. Generally, a computer will also include, or be operatively coupled to receive data from, or transfer data to, or both, one or more machine-readable storage media, such as mass storage devices for storing data, e.g., magnetic, magneto-optical disks, or optical disks. Machine-readable storage media suitable for embodying computer program instructions and data include all forms of non-volatile storage area, including by way of example, semiconductor storage area devices, e.g., EPROM, EEPROM, and flash storage area devices; magnetic disks, e.g., internal hard disks or removable disks; magneto-optical disks; and CD-ROM and DVD-ROM disks.

Any connection involving electrical circuitry that allows signals to flow, unless stated otherwise, is an electrical connection and not necessarily a direct physical connection regardless of whether the word “electrical” is used to modify “connection”.

Elements of different implementations described herein may be combined to form other embodiments not specifically set forth above. Elements may be left out of the structures described herein without adversely affecting their operation. Furthermore, various separate elements may be combined into one or more individual elements to perform the functions described herein.

What is claimed is:

1. A system comprising an autonomous device, the system comprising:
a movement assembly to move the autonomous device;
memory storing information about classes of objects and storing rules governing operation of the autonomous device based on a class of an object in a path of the autonomous device;
one or more sensors configured to detect at least one attribute of the object; and
one or more processing devices to perform operations comprising:
determining the class of the object based on the at least one attribute;
executing a rule to control the autonomous device based on the class; and
controlling the movement assembly based on the rule;
wherein, in a case that the object is classified as an animate object, the rule to control the autonomous device comprises instructions for determining a likelihood of a collision with the object and for outputting an alert based on the likelihood of the collision.

2. The system of claim 1, wherein the classes of objects and rules are stored in the form of a machine learning model.

3. The system of claim 1, wherein, in a case that the object is classified as an animate object, the rule to control the autonomous device comprises instructions for:
controlling the movement assembly to change a speed of the autonomous device;
detecting attributes of the object using the one or more sensors; and
reacting to the object based on the attributes.

4. The system of claim 1, wherein, in a case that the object is classified as an animate object, the rule to control the autonomous device comprises instructions for stopping movement of the autonomous device.

5. The system of claim 1, wherein, in a case that the object is classified as an animate object, the rule to control the autonomous device comprises instructions for altering a course of the autonomous device.

6. The system of claim 5, wherein the instructions for altering the course of the autonomous device comprise instructions for estimating a direction of motion of the animate object and for altering the course based on the direction of motion.

7. The system of claim 1, wherein the animate object is a human; and
wherein the alert comprises an audible or visual warning to move out of the way of the autonomous device.

8. The system of claim 1, wherein, in a case that the object is classified as an animate object, the rule to control the autonomous device comprises instructions for reacting to the object based on a parameter indicative of a level of aggressiveness of the autonomous device.

9. The system of claim 1, wherein the autonomous device is a mobile robot.

10. A system comprising an autonomous device, the system comprising:
a movement assembly to move the autonomous device;
memory storing information about classes of objects and storing rules governing operation of the autonomous device based on a class of an object in a path of the autonomous device;
one or more sensors configured to detect at least one attribute of the object; and
one or more processing devices to perform operations comprising:
determining the class of the object based on the at least one attribute;
executing a rule to control the autonomous device based on the class; and
controlling the movement assembly based on the rule;
wherein, in a case that the object is classified as a known robot, the rule to control the autonomous device comprises instructions for implementing communication to resolve a potential collision with the known robot.

11. The system of claim 10, wherein the classes of objects and rules are stored in the form of a machine learning model.

12. The system device of claim 10, wherein the instructions for implementing communication to resolve the potential collision comprise instructions for communicating with the known robot to negotiate the course.

13. The system device of claim 10, wherein the instructions for implementing communication to resolve the potential collision comprise instructions for communicating with a control system to negotiate the course.

14. The system device of claim 13, wherein the control system is configured to control operation of both the autonomous device and the known robot.

15. The system device of claim 14, wherein the control system comprises a computing system that is remote to both the autonomous device and the known robot.

16. The system device of claim 13, wherein the at least one attribute comprises information obtained from the known robot that the known robot is capable of communicating with the autonomous device.

17. The system device of claim 10, wherein the autonomous device is a mobile robot.

18. A system comprising an autonomous device, the system comprising:
a movement assembly to move the autonomous device;
memory storing information about classes of objects and storing rules governing operation of the autonomous device based on a class of an object in a path of the autonomous device;
one or more sensors configured to detect at least one attribute of the object; and
one or more processing devices to perform operations comprising:
determining the class of the object based on the at least one attribute;
executing a rule to control the autonomous device based on the class; and
controlling the movement assembly based on the rule;
wherein, in a case that the object is classified as a static object, the rule to control the autonomous device comprises instructions for avoiding collision with the object and for cataloging the object if the object is unknown.

19. The system of claim 18, wherein the classes of objects and rules are stored in the form of a machine learning model.

20. The system of claim 18, wherein the rule to control the autonomous device comprises instructions for:
comparing information about the object obtained through the one or more sensors to information in a database; and
determining whether the object is an unknown object based on the comparing.

21. The system of claim 20, wherein the rule to control the autonomous device comprises instructions for storing information in the database about the object if the object is determined to be an unknown object.

22. The system of claim 21, wherein the information comprises a location of the object.

23. The system of claim 21, wherein the information comprises one or more features of the object.

24. The autonomous device of claim 18, wherein the autonomous device is a mobile robot.

25. A system comprising an autonomous device, the system comprising:
a movement assembly to move the autonomous device;
memory storing information about classes of objects and storing rules governing operation of the autonomous device based on a class of an object in a path of the autonomous device;
one or more sensors configured to detect at least one attribute of the object; and
one or more processing devices to perform operations comprising:
determining the class of the object based on the at least one attribute;
executing a rule to control the autonomous device based on the class; and
controlling the movement assembly based on the rule;
wherein, in a case that the object is classified as an unknown dynamic object, the rule to control the autonomous device comprises instructions for determining a likely direction of motion of the unknown dynamic object and for controlling the movement assembly to avoid the unknown dynamic object.

26. The system of claim 25, wherein the classes of objects and rules are stored in the form of a machine learning model.

27. The system of claim 25, wherein the rule to control the autonomous device comprises instructions for determining a speed of the unknown dynamic object and for controlling the movement assembly based, at least in part, on the speed.

28. The system of claim 25, wherein controlling the movement assembly to avoid the unknown dynamic object comprises altering a course of the autonomous device.

29. The system of claim 28, wherein the course of the autonomous device is altered based on the likely direction of motion of the unknown dynamic object.

30. The system of claim 25, wherein the rule to control the autonomous device comprises instructions for:
controlling the movement assembly to change a speed of the autonomous device;
detecting attributes of the object using the one or more sensors; and
reacting to the object based on the attributes.

31. The autonomous device of claim 25, wherein the autonomous device is a mobile robot.
